(19) United States
(12) Patent Application Publication
(10) Pub. No.: US 2009/0269127 A1
(43) Pub. Date: Oct. 29, 2009

(54) LEVER MOUNTING ARRANGEMENT COMPRISING AN INJECTED SLIDING BEARING

(75) Inventor: Bernd HARTMANN, WEISENDORF (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/429,298

(22) Filed: Apr. 24, 2009

(30) Foreign Application Priority Data
Apr. 26, 2008 (DE) 10 2008 021 037.4

(51) Int. Cl. F16C 11/04; B21D 53/10

(52) U.S. Cl. 403/119; 29/898.12

(57) ABSTRACT

A lever mounting arrangement of a pivotable lever configured as a cast part and mounted through a hub for pivoting on a stationary axle. A sliding bearing, configured as a plastic bushing, is inserted into an annular gap defined in radial direction by a forming contour and a peripheral surface of the axle. The sliding bearing is made by injecting plastic material in an injection molding tool into the hub of the lever onto an unprocessed forming contour, the sliding bearing has friction-reducing and/or wear-reducing elements and a seal.

### FIELD OF THE INVENTION

The invention concerns a lever mounting arrangement of a pivotable lever that is configured as a cast part and mounted through a hub for pivoting on a stationary axle or shaft. A sliding bearing is inserted into an annular gap defined in radial direction by a reception bore of the hub and a peripheral surface of the axle.

### BACKGROUND OF THE INVENTION

A lever mounting arrangement of the pre-cited type is known, for instance, from the document DE 195 23 647 A1. This document shows a pivoting lever tensioning device in which a lever designated as a tensioning lever and configured as a toggle lever out of a casting material is rotatable about a stationary axle. In the operational state, a tension roller-arranged for rotation on a first end of the lever is supported by force-locking on a traction element of a traction drive. Force loading is effected through a tension spring element that is articulated on a further end of the lever and force-loads the lever in anti-clockwise direction. For forming the lever mounting arrangement, the hub comprises a reception bore made by mechanical processing. The lever is mounted for rotation on the axle through two axially spaced sliding bearing bushings inserted into the reception bore. To each front end of the lever hub is associated a washer that is positionally fixed on the axle and serves to guide the lever in axial direction. For sealing an annular gap defined by the installation space of the sliding bearing, sealing rings are provided at both front ends. These elastically deformable sealing rings are inserted into a front-end reception of the hub and are sealed relative to the hub and to the peripheral surface of the axle as also relative to the washer. A drawback of this prior art lever mounting arrangement is the high cost of processing and assembly due to the large number of components.

### OBJECTS OF THE INVENTION

It is an object of the invention to provide a lever mounting arrangement optimized with regard to the number of components and costs.

This and other objects and advantages of the invention will become obvious from the following detailed description.

### SUMMARY OF THE INVENTION

The invention achieves its objects by the fact that a sliding bearing in form of a bushing of a plastic material is injected into the unprocessed reception bore of the hub of the cast lever. Through this measure, advantageously, there is no need to chuck the cast lever for a cost-intensive machine-finishing of the reception bore in form of a fitting bore as in the prior art for receiving the sliding bearing prior to insertion of sealing rings into the reception bore. Disadvantageously, tolerances cumulate due to the finishing treatment of the reception bore and the wall thickness of the sliding bearing and directly determine the sliding bearing lash relative to the bearing pin or axle. Through the invention, advantageously, the desired closely toleranced mounting lash between the sliding bearing and the bushing or the axle can be attained by the injection of the plastic material into the injection molding die. The number of components of the inventive lever mounting arrangement that includes an injected plastic bushing forming the sliding bearing is reduced compared to known solutions, and this has a direct advantageous effect on the tolerance chain. Moreover, the invention reduces the number of work steps and components, so that, together with a closely toleranced sliding bearing lash, an optimal lever mounting arrangement is realized. For obtaining an improved durability of the lever mounting arrangement, the invention advantageously proposes to provide the plastic bushing that forms the sliding bearing with friction-reducing and/or wear-reducing elements. The injected plastic bushing configured as a multi-function component can further comprise at least one seal that is integrally connected to the plastic bushing.

The outer contour or peripheral surface of the inventive injected plastic bushing that constitutes the sliding bearing enables the production-inherent inclined forming surfaces or contours of the reception bore of the hub made by casting to be compensated or leveled without pre-treatment. Thus, advantageously, no tolerance requirements or other special requirements need to be made of the surface structure in the region of the reception bore of the cast lever made particularly as an aluminum die-casting. In this connection, the shape of the forming contour plays no role because the inventive plastic bushing levels, for example, even a conical or a convex forming contour.

Keeping in mind the intended multi-functionality of the inventive sliding bearing, this bearing may further comprise, at least on one front end, an integrally formed right-angled rim that assumes the function of a thrust bearing. A sliding bearing of the invention with such a configuration can be used, for instance, in a lever mounting arrangement in which the lever hub is loaded by an axial force, i.e. requires a thrust bearing.

Moreover, the sliding bearing of the invention can comprise, at least on one side, a flexible seal integrally connected to the sliding bearing. If need be and depending on installation conditions, it may be appropriate to provide a flexible seal on both ends of the sliding bearing. For achieving an improved sealing effect, the seal preferably comprises an inclined sealing lip extending radially outward. In the installed state, this sealing lip is supported by force-locking on a contact surface. Another suitable seal can be made in the form of a sealing element or seal comprising two radially outward directed sealing lips forming a V-shaped cross-sectional profile. Through this spread arrangement of the sealing lips, each of these sealing lips can be supported by force-locking in a sealing gap between the lever hub and, for example, a washer disposed on the stationary axle. In a further configuration, the seal comprises two sealing lips offset radially to each other, so that, for example, an inner sealing lip is supported on the lever and an outer sealing lip is supported on a component adjoining the lever.

The invention further proposes as a measure for obtaining a friction-optimized sliding bearing, an enrichment of the plastic material of the sliding bearing with a lubricant, particularly PTFE. Appropriately, for example, the lubricant is inserted in the form of lamellae into the plastic material, so that independently of the state of wear of the sliding bearing, an adequate quantity of lubricant is present in the contact zone between the stationary axle and the sliding bearing.

A particularly suitable plastic as base material for the sliding bearing is preferably a polymer compound that, interspersed with a suitable lubricant, forms the sliding bearing. It is further possible to make the sliding bearing of the invention as a one-component plastic part or a two-component plastic part. An appropriate measure for realizing an improved shape stability or general rigidity of the sliding bearing is to provide the sliding bearing with an armoring in the form of a hard plastic element.

The lever configured as a casting is preferably made of aluminum. A particularly suitable and preferred cost-optimized fabrication method even for large piece numbers is die-casting.

The lever mounting arrangement of the invention is particularly intended for a tensioning system of traction drive in which a pivotable lever loaded through force-locking by a spring means is supported in the installed state by force-locking through a tension roller on a traction element.

The invention further concerns a fabrication method for the lever mounting arrangement of the invention comprising the following fabrication steps. In a first step, the lever configured as a casting comprising an unprocessed forming contour is positioned in the lever hub in an injection molding tool. In a next step, the sliding bearing is formed by injection of a plastic material into the lever hub, so that a peripheral surface of the sliding bearing levels the forming contour of the hub, and the sliding bearing is thus fitted by positive engagement. By virtue of this method, advantageously, no special requirements are made of the surface structure or tolerances in the region of the forming contour of the lever made as a die-cast part. At the same time, the method clearly reduces the costs of assembly because both a mechanical finishing of a reception bore and the pressing-in of the sliding bearing as also the insertion of seals are omitted. The injected plastic sliding bearing of the invention is suitable for many uses. Moreover, by providing sufficiently large contact surfaces between the sliding bearing and the associated axle or shaft, the surface contact pressure and the concomitant load rating of the sliding bearing can be reduced, so that plastic as a base material for the sliding bearing is adequate enough for achieving a long durability of the inventive lever mounting arrangement.

### BRIEF DESCRIPTION OF THE DRAWINGS

Further advantages and details of the invention will now be described with reference to examples of embodiment and the appended figures showing schematic representations.

FIG. 1 shows the structure of a lever mounting arrangement in a prior art tensioning system,

FIG. 2 shows a detail of a lever mounting arrangement of the invention, associated to a lever,

FIG. 3 shows an alternative to FIG. 2, the sliding bearing also forming through a front-end rim, a thrust bearing,

FIG. 4 shows a sliding bearing comprising a seal comprising V-shaped sealing lips, and

FIG. 5 shows a hub of a lever comprising a convex forming contour to which a sliding bearing is associated.

### DETAILED DESCRIPTION OF THE DRAWINGS

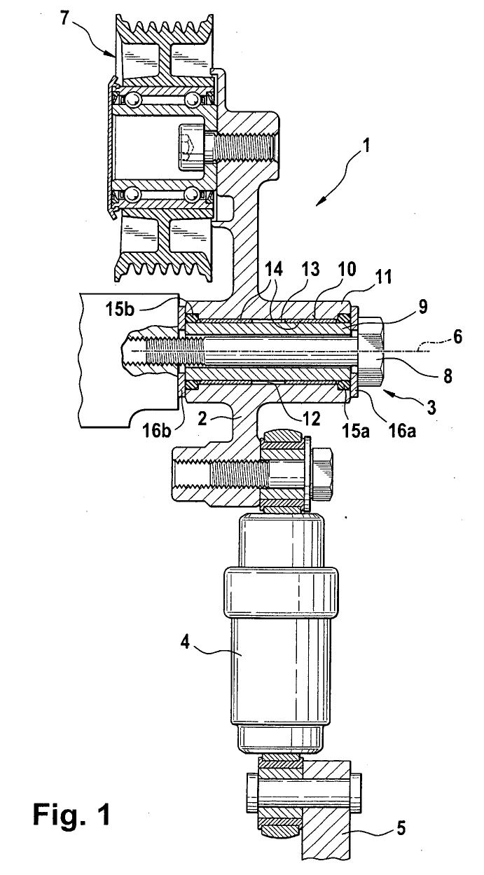

FIG. 1 shows a prior art tensioning system 1 through which, for example, a traction element, particularly a belt of a traction drive is pre-stressed. The construction comprises a lever 2 that can also be designated as a pivoting lever that is pivotable through a lever mounting arrangement 3. The lever 2, preferably made as an aluminum die-casting, is articulated at one end on a mechanical or spring element 4 that, in its turn, is supported through articulation on a stationary housing 5. The spring element 4 which introduces a component force into the lever 2 causes a pivoting of the lever 2 about an axis of rotation 6 of the lever mounting arrangement 3, so that a tension roller 7 disposed on a free end of the lever 2 is supported by force-locking on a traction element, not shown in FIG. 1. The lever mounting arrangement 3 comprises a screw connection 8 through which a bearing bushing serving as an axle 9 is positionally fixed on the housing 5. The axle 9 is inserted into a reception bore 10 of a hub 11 of the lever 2. An annular gap 12 defined radially by the reception bore 10 of the hub 11 and a peripheral surface 13 of the axle 9 serves to lodge a sliding bearing 14 made up of two axially spaced bushings. For sealing the annular gap 12, seals 15a, 15b are arranged at both ends of the hub 11. The lever mounting arrangement 3 further comprises two washers 16a, 16b that serve as axial guides of the hub 11 and are arranged in respective stepped regions of the axle 9 such that an axial lash is formed at each front end of the hub 11.

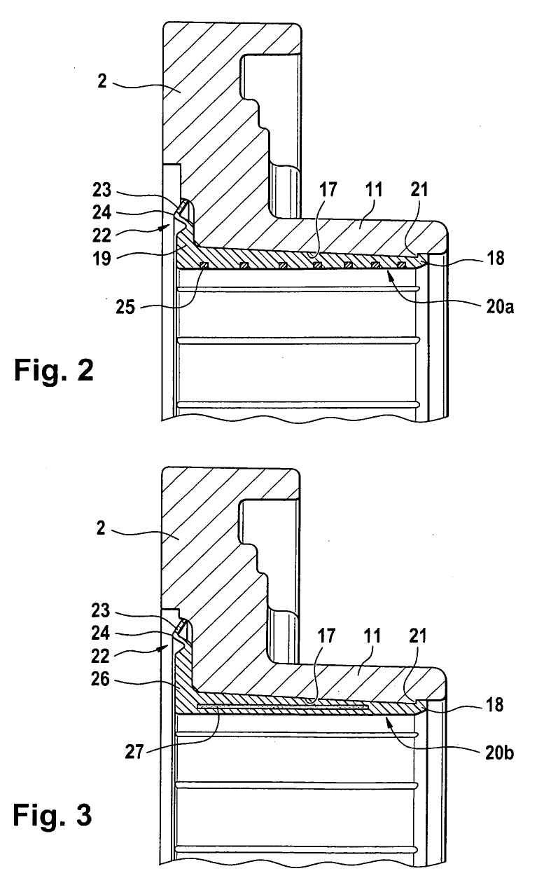

FIGS. 2 to 5 show alternatives to the lever mounting arrangement 3 of FIG. 1 concerning the configuration of the sliding bearing. All these figures show a detail of the lever 2 together with the respective sliding bearing of the invention.

FIG. 2 shows the lever 2 in which, in place of a reception bore, the hub 11 comprises a conical, tapering forming contour 17 that is formed due to production conditions of the lever 2 made as a casting. The sliding bearing 20a is constituted by a plastic bushing that extends over almost the entire width of the hub 11 and is formed by a direct injection of a plastic material onto the forming contour 17. For this purpose, the lever 2 is inserted and positioned in an injection molding tool. This configuration of the sliding bearing requires neither a processing of the forming contour 17 nor a mechanical finishing of the inner contour of the sliding bearing. The shape of the sliding bearing 20a configured as a plastic bushing matches itself directly to the shape of the forming contour 17 and the inner side of the sliding bearing 20a is cylindrical in shape, for instance, for receiving the axle 9 according to FIG. 1. For realizing a positionally fixed arrangement, the sliding bearing 20a comprises on both ends a radially outward oriented rim 18, 19 that effects a positive locking on the hub 11 by the fact that the rim 18 engages behind a radial step 21 of the hub 11. A front end of the opposing rim 19 is supported on the lever 2. On its periphery, the rim 19 comprises a seal 22 whose elastic sealing lip 23 is supported at one end on the lever 1. In the non-installed state, the sealing lip 23 forms a contour projecting beyond the front end of the rim 19. In the installed state of the sealing lip 23, this contour is in flat, sealing contact through a sealing surface 24, for example, on the washer 16b according to FIG. 1. As a measure for reducing friction, lubricant 25, for example PTFE in the form of lamellae, is embedded in the sliding bearing 20a and comes into direct contact with the axle 9 in the installed state for creating an adequate lubricant film in the contact zone between the sliding bearing 20a and the axle 9.

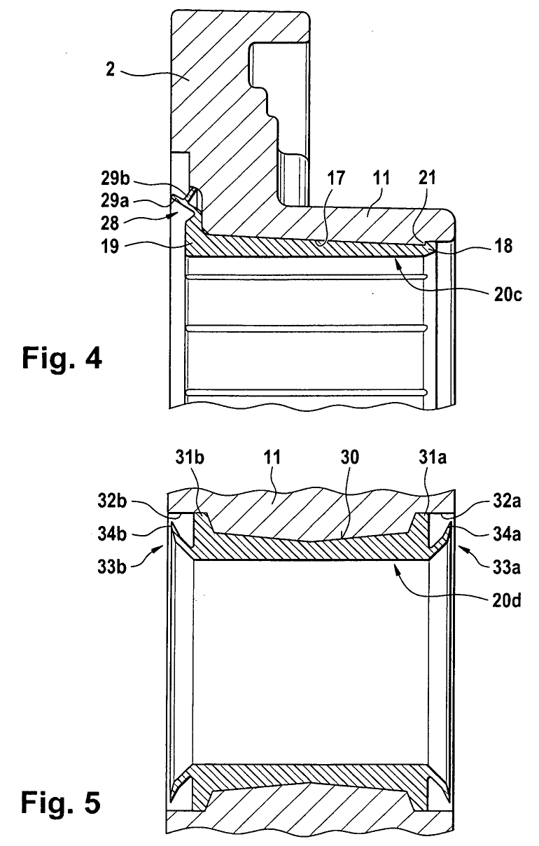

FIGS. 3 and 4 show the sliding bearings 20b and 20c that are inserted respectively into the lever 2. The following descriptions are restricted exclusively to the different configurations and different features of the sliding bearings 20b, 20c with respect to the sliding bearing 20a of FIG. 2.

The bearing 20b shown in FIG. 3 is a multi-function component comprising on the end turned away from the rim 18 a thrust bearing 26. The thrust bearing 26 is formed by a rim that emerges integrally from the substantially cylindrical sliding bearing 20b. On the outer side, the thrust bearing 26 is surrounded by a seal 22 comprising a sealing lip 23. For achieving an improved strength or rigidity, the sliding bearing 20b comprises an armoring 27 which is appropriately made, for instance, as an annular insert out of carbon fibers.

The sliding bearing 20c of FIG. 4 comprises a seal 28 starting from the rim 19 and comprising V-shaped sealing lips 19a, 29b that are associated to the lever 2 or to the washer 16b shown in FIG. 1.

The hub 11 shown in FIG. 5 comprises a forming contour 30 having oppositely oriented forming inclinations or an approximately convex forming contour. The peripheral surface of the sliding bearing 20d is matched to this shape. At each front end, the sliding bearing 20d forms radially extending circumferential rims 31a, 31b of the same size that snap onto respective stepped zones 32a, 32b of the hub 11. In conformity with the symmetry of the sliding bearing 20d, identical seals 33a, 33b comprising sealing lips 34a, 34b extending at an inclination radially outwards are associated respectively to the rims 31a, 31b.

### LIST OF REFERENCE NUMERALS

1 Tensioning system
2 Lever
3 Lever mounting arrangement
4 Spring element
5 Housing
6 Axis of rotation
7 Tension roller
8 Screw connection
9 Axle
10 Reception bore
11 Hub
12 Annular gap
13 Peripheral surface
14 Sliding bearing
15a Seal
15b Seal
16a Washer
16b Washer
17 Forming contour
18 Rim
19 Rim
20a Sliding bearing
20b Sliding bearing
20c Sliding bearing
20d Sliding bearing
21 Step
22 Seal
23 Sealing lip
24 Sealing surface
25 Lubricant
26 Thrust bearing
27 Armoring
28 Seal
29a Sealing lip
29b Sealing lip
30 Forming contour
31a Rim
31b Rim
32a Zone
32b Zone
33a Seal
33b Seal
34a Sealing lip
34b Sealing lip

1. A lever mounting arrangement of a pivotable lever configured as a cast part and mounted through a hub for pivoting on a stationary axle or shaft, an at least partially sealed sliding bearing being inserted into an annular gap defined radially by a reception bore or a forming contour of the hub and a peripheral surface of the axle, wherein, for forming the sliding bearing, a plastic material is injected into the axle of the lever onto an unprocessed forming contour, the sliding bearing comprising friction-reducing elements or wear-reducing elements, and further comprising at least one seal.

2. A lever mounting arrangement according to claim 1, wherein a peripheral surface of the sliding bearing made of the plastic material levels the forming contour and forms a cylindrical inner contour.

3. A lever mounting arrangement according to claim 2, wherein the forming contour has a conical or an approximately convex shape.

4. A lever mounting arrangement according to claim 1, wherein, for forming a multi-function component, the sliding bearing comprises, on at least one front end, an integrally formed, right-angled rim that forms a thrust bearing.

5. A lever mounting arrangement according to claim 1, wherein, for creating a positionally fixed installation position, the sliding bearing comprises radially outwards oriented rims that cooperate with a step or a front end of the hub.

6. A lever mounting arrangement according to claim 1, wherein the seal comprises a sealing lip extending radially outwards at a slant.

7. A lever mounting arrangement according to claim 1, wherein the seal comprises two sealing lips oriented radially outwards and forming a V-shaped cross-sectional profile.

8. A lever mounting arrangement according to claim 1, wherein the seal comprises two radially offset sealing lips, an inner one of the sealing lips being supported on the lever and an outer one of the sealing lips being supported on a component adjoining the lever.

9. A lever mounting arrangement according to claim 1, wherein PTFE is deposited as a lubricant in the sliding bearing.

10. A lever mounting arrangement according to claim 1, wherein a polymer compound is provided as a base material for the sliding bearing.

11. A lever mounting arrangement according to claim 1, wherein the sliding bearing is configured as a one-component plastic part or a two-component plastic part.

12. A lever mounting arrangement according to claim 1, wherein, for achieving an improved strength, the sliding bearing comprises an armoring.

13. A lever mounting arrangement according to claim 1, wherein the lever is configured as an aluminum die-cast part.

14. A lever mounting arrangement according to claim 1, wherein the sliding bearing is installed in a lever mounting arrangement of a tensioning system.

15. A method of making a lever mounting arrangement according to claim 1, comprising the following steps:
insertion of the lever, configured as a casting having an unprocessed forming contour on the hub of the lever, into an injection molding tool;
injection of the plastic material into the hub of the lever for forming a sliding bearing so that the sliding bearing levels the forming contour and gets fitted through positive engagement, the sliding bearing having at least one of friction-reducing elements or wear-reducing elements and at least one seal.
